(19) United States
(12) Patent Application Publication
(10) Pub. No.: US 2026/0039180 A1
(43) Pub. Date: Feb. 5, 2026

(54) Power Supply Control Device, Power Supply Device, and Electronic Apparatus

(71) Applicant: ROHM CO., LTD., KYOTO (JP)

(72) Inventor: Akinori YAMAMOTO, KYOTO (JP)

(21) Appl. No.: 19/284,260

(22) Filed: Jul. 29, 2025

(30) Foreign Application Priority Data
Jul. 31, 2024 (JP) 2024-124468

(51) Int. Cl. H02M 1/00; G05F 1/571; G05F 1/575; H02M 1/088

(52) U.S. Cl. CPC H02M 1/0032; G05F 1/571; G05F 1/575; H02M 1/0009; H02M 1/0045; H02M 1/088

(57) ABSTRACT

A power supply control device includes an output feedback terminal, a power supply control circuit that controls an output voltage according to a terminal voltage of the output feedback terminal when enabled, an output monitoring circuit that monitors the terminal voltage regardless of whether the power supply control circuit is enabled or disabled, and a logic circuit that switches an enable/disable setting of the power supply control circuit and generate an output signal according to a monitoring result of the terminal voltage.

### TECHNICAL FIELD

The present disclosure relates to a power supply control device, a power supply device, and an electronic apparatus.

### BACKGROUND

Power supply devices can be installed in various applications.

Furthermore, an example of conventional technology related to the above is seen in Patent Document 1.

### PRIOR ART DOCUMENT

### Patent Document

[Patent Document 1] Japan Patent Publication No. 2021-191195.

### BRIEF DESCRIPTION OF THE DRAWINGS

FIG. 1 is a diagram showing an overall configuration (first example) of an electronic apparatus.

FIG. 2 is a diagram showing a comparative example of a power supply control device.

FIG. 3 is a diagram showing an overall configuration (second example) of an electronic apparatus.

FIG. 4 is a diagram showing a first embodiment of a power supply control device.

FIG. 5 is a diagram showing an overall configuration (third example) of an electronic apparatus.

FIG. 6 is a diagram showing a second embodiment of a power supply control device.

FIG. 7 is a diagram showing mode switching control in the second embodiment.

FIG. 8 is a diagram showing a third embodiment of a power supply control device.

FIG. 9 is a diagram showing mode switching control in the third embodiment.

FIG. 10 is a diagram showing a fourth embodiment of a power supply control device.

FIG. 11 is a diagram showing mode switching control in the fourth embodiment.

FIG. 12 is a diagram showing a fifth embodiment of a power supply control device.

FIG. 13 is a diagram showing mode switching control in the fifth embodiment.

FIG. 14 is a diagram showing a configuration example of a power supply control circuit and an output monitoring circuit.

### DETAILED DESCRIPTION OF THE EMBODIMENTS

### Electronic Apparatus (First Example)

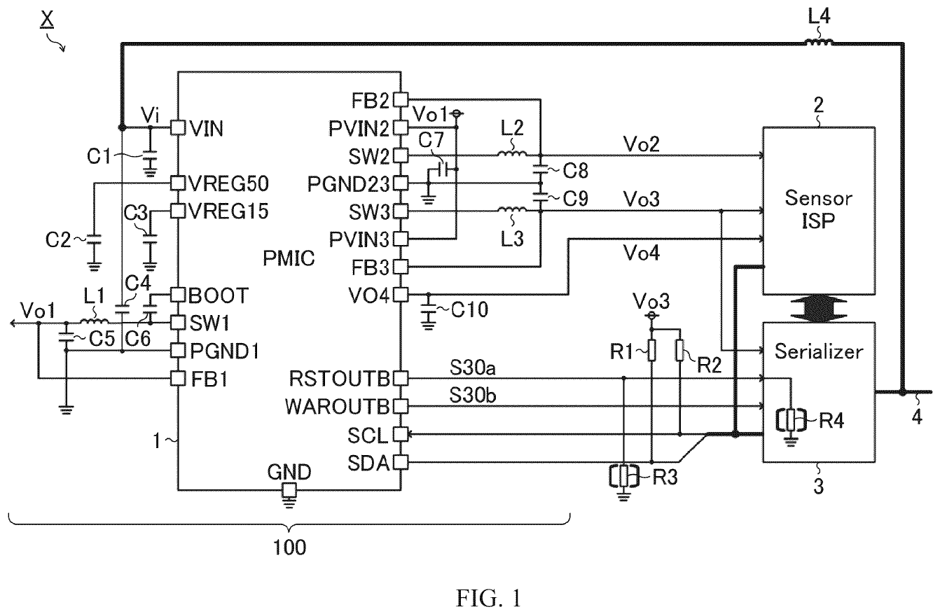

FIG. 1 is a diagram showing an overall configuration (first example) of an electronic apparatus X. The electronic apparatus X of this configuration example comprises a power supply control device 1, a load device 2, a signal processing device 3, a coaxial cable 4, and various discrete components (in this figure, capacitors C1 to C10, inductors L1 to L4, and resistors R1 and R2). For example, the electronic apparatus X may be an in-vehicle camera module.

The power supply control device 1 functions as a control main body of a power supply device 100, which generates multiple output voltages Vo1 to Vo4. The power supply control device 1 may be a composite power supply IC [integrated circuit](a so-called PMIC [power management IC]).

The power supply control device 1 comprises, as means for establishing electrical connections with an outside of the device, a boot terminal BOOT, output feedback terminals FB1 to FB3, a ground terminal GND, ground terminals PGND1 and PGND23, input terminals PVIN2 and PVIN3, a reset output terminal RSTOUTB, a clock communication terminal SCL, a data communication terminal SDA, switch terminals SW1 to SW3, an input terminal VIN, an output terminal VO4, reference voltage terminals VREG15 and VREG50, and a warning output terminal WAROUTB.

The capacitor C1 is connected between the input terminal VIN (=an application end of an input voltage V1) and a ground end. The capacitor C2 is connected between the reference voltage terminal VREG50 (=an application end of the reference voltage Vreg50) and the ground end. The capacitor C3 is connected between the reference voltage terminal VREG15 (=an application end of the reference voltage Vreg15) and the ground end. The capacitor C4 is connected between the input terminal VIN and the ground terminal PGND1. The capacitor C5 is connected between an application end of the output voltage Vo1 and the ground end. The capacitor C6 is connected between the boot terminal BOOT and the switch terminal SW1. The capacitor C7 is connected between the input terminals PVIN2 and PVIN3 and the ground terminal PGND23. The input terminals PVIN2 and PVIN3 are connected to the application end of the output voltage Vo1. The capacitor C8 is connected between an application end of an output voltage Vo2 and the ground terminal PGND23. The capacitor C9 is connected between an application end of an output voltage Vo3 and the ground terminal PGND23. The capacitor C10 is connected between the output terminal VO4 (=an application end of an output voltage Vo4) and the ground end. The ground terminal PGND1, the ground terminal PGND23, and the ground terminal GND are all connected to the ground end.

The inductor L1 is connected between the switch terminal SW1 and the application end of the output voltage Vo1. The inductor L2 is connected between the switch terminal SW2 and the application end of the output voltage Vo2. The inductor L3 is connected between the switch terminal SW3 and the application end of the output voltage Vo3. The inductor L4 is connected between the input terminal VIN and the coaxial cable 4.

The resistor R1 is connected between the application end of the output voltage Vo3 and the data communication terminal SDA. The resistor R2 is connected between the application end of the output voltage Vo3 and the clock communication terminal SCL. An external resistor R3 or an internal resistor R4 built in the signal processing device 3 may be connected between the reset output terminal RSTOUTB and the ground end.

The output feedback terminal FB1 is connected to the application end of the output voltage Vo1. The power supply control device 1 connected in this manner forms a first channel DC [direct current]/DC converter [=primary power supply] with the capacitors C5 to C6 and the inductor L1, generating the output voltage Vo1 from the input voltage V1.

The output feedback terminal FB2 is connected to the application end of the output voltage Vo2. The power supply control device 1 connected in this manner forms a second channel DC/DC converter (=one of secondary power supplies) with the capacitor C8 and the inductor L2, generating the output voltage Vo2 from the output voltage Vo1.

The output feedback terminal FB3 is connected to the application end of the output voltage Vo3. The power supply control device 1 connected in this manner forms a third channel DC/DC converter (=one of the secondary power supplies) with the capacitor C8 and the inductor L2, generating the output voltage Vo3 from the output voltage Vo1.

Additionally, the power supply control device 1 forms a fourth channel LDO [low drop out] regulator (=one of the secondary power supplies), generating the output voltage Vo4 from the output voltage Vo1.

The input voltage V1 may be, for example, 4 to 18 V. The output voltage Vo1 may be, for example, 3 to 5 V. The output voltages Vo2 and Vo3 may each be, for example, 0.8 to 1.8 V. The output voltage Vo4 may be, for example, 2 to 3 V.

The load device 2 operates upon receiving a supply of each of the output voltages Vo2, Vo3, and Vo4 from the power supply device 100. The load device 2 is connected to the clock communication terminal SCL and the data communication terminal SDA, and conducts serial communication between the power supply control device 1 and the signal processing device 3 in accordance with the I²C [inter-integrated circuit] communication protocol. Additionally, the load device 2 also conducts parallel communication with the signal processing device 3. The load device 2 may be, for example, a sensor ISP [image signal processor] such as an in-vehicle camera, etc.

The signal processing device 3 operates upon receiving a supply of the output voltage Vo3 from the power supply device 100. The signal processing device 3 is connected to the clock communication terminal SCL and the data communication terminal SDA, and conducts serial communication between the power supply control device 1 and the load device 2 in accordance with the I²C communication protocol. Additionally, the signal processing device 3 also conducts parallel communication with the load device 2. Moreover, the signal processing device 3 is also connected to the reset output terminal RSTOUTB and the warning output terminal WAROUTB, receiving an input of a reset output signal S30a and a warning output signal S30b from the power supply control device 1. The signal processing device 3 may be, for example, a serializer that converts a parallel signal output from the load device 2 into a serial signal.

The coaxial cable 4 serves as both a power supply path to the power supply control device 1 and a communication path for the signal processing device 3. As such, in the electronic apparatus X, a PoC [power over coax] system that transmits both power and signals via the coaxial cable 4 may be adopted.

### Power Supply Control Device (Comparative Example)

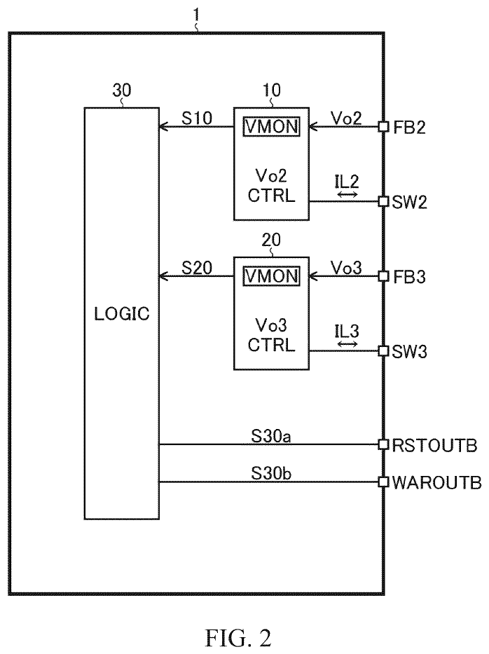

FIG. 2 is a diagram showing a comparative example of a power supply control device 1 (=an example of a key component configuration compared with embodiments described below). The power supply control device 1 of this comparative example includes power supply control circuits 10 and 20 and a logic circuit 30 as circuit elements forming the second channel and third channel DC/DC converters, respectively.

The power supply control circuit 10 performs drive control of an output current IL2 flowing through the switch terminal SW2 so that the output voltage Vo2 applied to the output feedback terminal FB2 matches a target value. Additionally, the power supply control circuit 10 comprises an output monitoring function that monitors whether an anomaly or its precursor has occurred in the output voltage Vo2 and generates an anomaly detection signal S10.

The power supply control circuit 20 performs drive control of an output current IL3 flowing through the switch terminal SW3 so that the output voltage Vo3 applied to the output feedback terminal FB3 matches the target value. Additionally, the power supply control circuit 20 comprises an output monitoring function that monitors whether an anomaly or its precursor has occurred in the output voltage Vo3 and generates an anomaly detection signal S20.

The logic circuit 30 generates a reset output signal S30a and a warning output signal S30b in response to the anomaly detection signals S10 and S20.

The reset output signal S30a may be set to a low level when an anomaly occurs in at least one of the output voltages Vo2 and Vo3. On the other hand, the reset output signal S30a may be set to a high level when no anomaly occurs in either of the output voltages Vo2 and Vo3. Furthermore, the reset output signal S30a is output to the signal processing device 3 via the reset output terminal RSTOUTB.

Additionally, the warning output signal S30b may be set to a low level when a precursor of an anomaly occurs in at least one of the output voltages Vo2 and Vo3. On the other hand, the warning output signal S30b may be set to a high level when no precursor of an anomaly occurs in either of the output voltages Vo2 and Vo3. Furthermore, the warning output signal S30b is output to the signal processing device 3 from the warning output terminal WAROUTB.

Additionally, although not explicitly shown in this figure, the reset output signal S30a and the warning output signal S30b may also reflect a monitoring result of each of the output voltages Vo1 and Vo4, in addition to the monitoring result of each of the output voltages Vo2 and Vo3.

### Electronic Apparatus (Second Example)

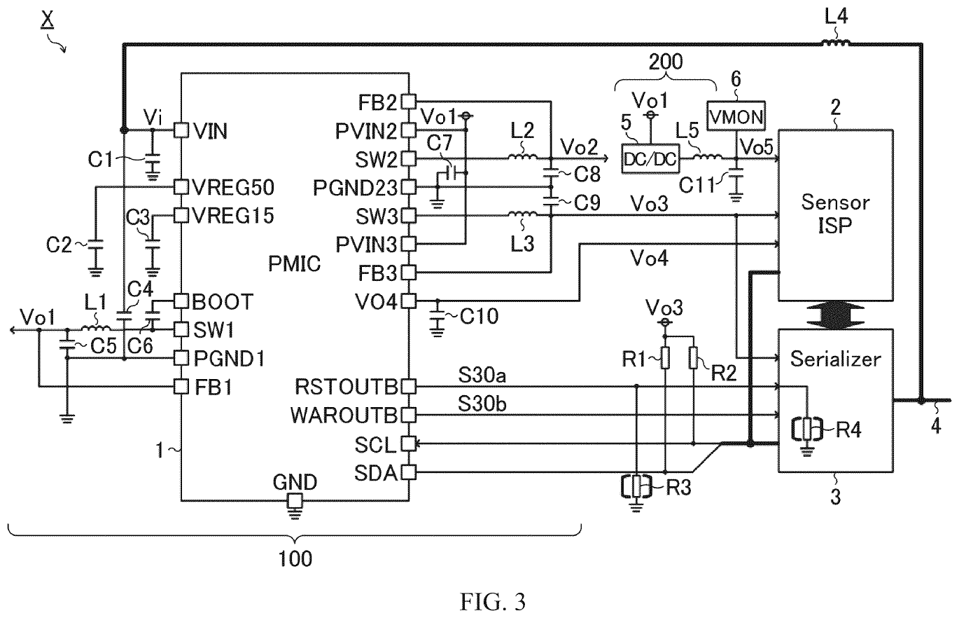

FIG. 3 is a diagram showing an overall configuration (second example) of an electronic apparatus X. The electronic apparatus X of this configuration example is based on the first example (FIG. 1) described above, and further comprises a power supply control device 5, an output monitoring device 6, a capacitor C11, and an inductor L5. Furthermore, the power supply control device 1 is the one shown in the aforementioned comparative example (FIG. 2).

The power supply control device 5 functions as a main control unit of a power supply device 200, which generates the output voltage Vo5 from the output voltage Vo1. The load device 2 receives a supply of each of the output voltages Vo3 and Vo4 from the power supply device 100 and operates upon receiving a supply of the output voltage Vo5 from the power supply device 200. Furthermore, it is preferable that the power supply device 200 has a current supply capability greater than that of the power supply device 100, that is, specifically, a capability of supplying a current necessary for an operation of the load device 2. The capacitor C11 is connected between an application end of the output voltage Vo5 and the ground end. The inductor L5 is connected between an output node (unillustrated switch terminal) of the power supply control device 5 and the application end of the output voltage Vo5.

The output monitoring device 6 monitors whether an anomaly or its precursor has occurred in the output voltage Vo5 and outputs this monitoring result to the signal processing device 3.

As shown in this figure, if the current supply capability of the power supply device 100 is insufficient for the load device 2, the power supply device 200 having the current supply capability greater than the power supply device 100 can be added to the electronic apparatus X.

However, unlike the multi-channel power supply control device 1, the single-channel power supply control device 5 often does not comprise an output monitoring function, in particular, a function for outputting a result of anomaly detection of the output voltage Vo5 to the outside of the device.

On the other hand, the output monitoring function of the power supply control circuit 10 installed in the power supply control device 1 of the comparative example (FIG. 2) is merely a function for monitoring the output voltage Vo2. Therefore, it is difficult to monitor the output voltage Vo5, which is not directly related to the power supply control circuit 10, as a monitoring target, instead of the unused output voltage Vo2.

For the above reasons, to monitor the output voltage Vo5 in the electronic apparatus X of this configuration example, it is necessary to add the output monitoring device 6. That is, in the electronic apparatus X of this configuration, the output monitoring function is distributed in each of the power supply control device 1 and the output monitoring device 6.

In the following, in light of the above considerations, a novel power supply control device 1 capable of centralizing the output monitoring function is proposed.

### Power Supply Control Device (First Embodiment)

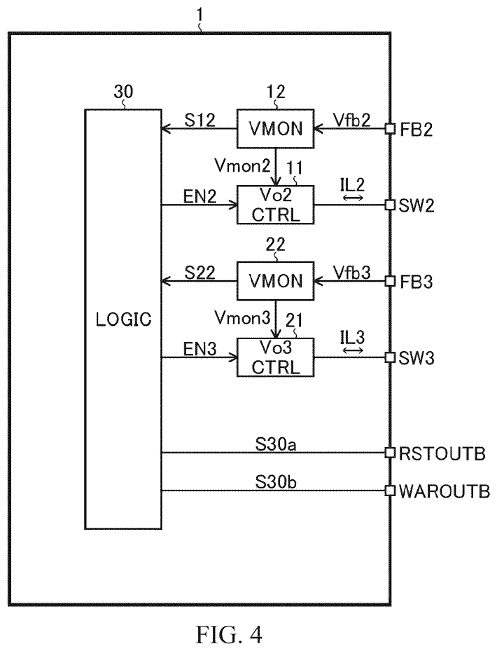

FIG. 4 is a diagram showing a first embodiment of the power supply control device 1. The power supply control device 1 of this embodiment is based on the aforementioned comparative example (FIG. 2) and comprises power supply control circuits 11 and 21 as well as output monitoring circuits 12 and 22 instead of the power supply control circuits 10 and 20.

The power supply control circuit 11 is switched between enabled and disabled in response to an enable signal EN2 output from the logic circuit 30.

When the power supply control circuit 11 is enabled, as shown in aforementioned FIG. 1, the output voltage Vo2 is fed back to the output feedback terminal FB2. At this time, the power supply control circuit 11 controls the output voltage Vo2 according to a terminal voltage Vfb2 (=output voltage Vo2) of the output feedback terminal FB2. To describe more specifically, the power supply control circuit 11 performs drive control of the output current IL2 flowing through the switch terminal SW2 so that a monitoring voltage Vmon2 output from the output monitoring circuit 12 matches a target value. The monitoring voltage Vmon2 may be a divided voltage of the terminal voltage Vfb2.

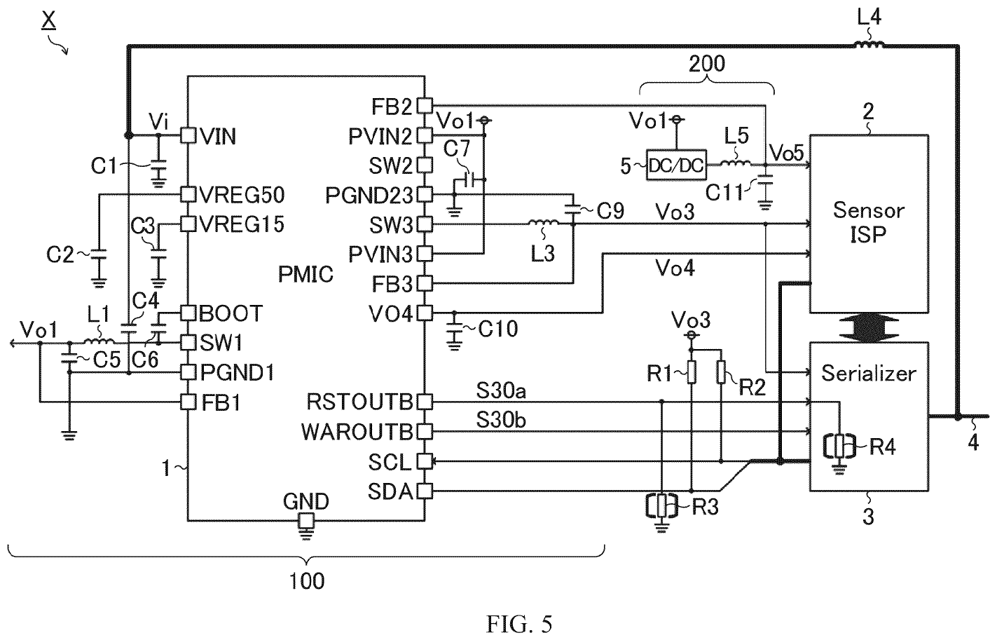

On the other hand, when the power supply control circuit 11 is disabled, the drive control of the output current IL2 is stopped. For example, the switch terminal SW2 may be set to an open state, as shown in FIG. 5 below. At this time, instead of the unused output voltage Vo2, for example, the output voltage Vo5 may be applied to the output feedback terminal FB2.

The output monitoring circuit 12 monitors whether an anomaly or its precursor has occurred in the terminal voltage Vfb2 and generates an anomaly detection signal S12, regardless of whether the power supply control circuit 11 is enabled or disabled. Furthermore, when the power supply control circuit 11 is enabled, the output voltage Vo2 is set to be a monitoring target of the output monitoring circuit 12. On the other hand, when the power supply control circuit 11 is disabled, instead of the unused output voltage Vo2, for example, the output voltage Vo5 may be set to be a monitoring target of the output monitoring circuit 12.

The power supply control circuit 21 is switched between enabled and disabled according to an enable signal EN3 output from the logic circuit 30.

When the power supply control circuit 21 is enabled, as shown in aforementioned FIGS. 1 and 3, the output voltage Vo3 is fed back to the output feedback terminal FB3. At this time, the power supply control circuit 21 controls the output voltage Vo3 according to the terminal voltage Vfb3 (=output voltage Vo3) of the output feedback terminal FB3. To describe more specifically, the power supply control circuit 21 performs drive control of the output current IL3 flowing through the switch terminal SW3 so that a monitoring voltage Vmon3 output from the output monitoring circuit 22 matches the target value. The monitoring voltage Vmon3 may be a divided voltage of the terminal voltage Vfb3.

On the other hand, when the power supply control circuit 21 is disabled, the drive control of the output current IL3 is stopped. For example, the switch terminal SW3 may be set to an open state. At this time, instead of the unused output voltage Vo3, for example, the output voltage Vo5 may be applied to the output feedback terminal FB3.

The output monitoring circuit 22 monitors whether there is an anomaly or its precursor has occurred in the terminal voltage Vfb3 and generates an anomaly detection signal S22, regardless of whether the power supply control circuit 21 is enabled or disabled. Furthermore, when the power supply control circuit 21 is enabled, the output voltage Vo3 is set to be a monitoring target of the output monitoring circuit 22. On the other hand, when the power supply control circuit 21 is disabled, instead of the unused output voltage Vo3, for example, the output voltage Vo5 may be set to be a monitoring target of the output monitoring circuit 22.

As such, in the power supply control device 1 of this embodiment, the power supply control circuits 11 and 21 and the output monitoring circuits 12 and 22 are separated for the DC/DC converters (secondary power sources) that generate each of the output voltages Vo2 and Vo3.

Particularly, in a multi-channel power supply control device 1, it is preferable to provide multiple sets of output feedback terminals FB2 and FB3, power supply control circuits 11 and 21, and output monitoring circuits 12 and 22, specifically as many as the number of channels whose outputs can be disabled.

Additionally, although not explicitly shown in this figure, the power supply control circuit and the output monitoring circuit can also be separated for an LDO regulator (secondary power source) that generates the output voltage Vo4. In that case, when the output of the output voltage Vo4 is disabled, instead of the unused output voltage Vo4, for example, the output voltage Vo5 may be applied to the output terminal VO4.

On the other hand, in the DC/DC converter (primary power source) that generates the output voltage Vo1, it is hardly expected that the output of the output voltage Vo1 will be disabled. Therefore, separation of the power supply control circuit and the output monitoring circuit is not essential. However, if there is an opportunity to disable the output of the output voltage Vo1, it is not avoided to separate the power supply control circuit and the output monitoring circuit of the primary power supply and apply a voltage which becomes a monitoring target to the output feedback terminal FB1, instead of the unused output voltage Vo1.

The logic circuit 30 generates the enable signals EN2 and EN3 to switch an enable/disable setting of each of the power supply control circuits 11 and 21. Additionally, the logic circuit 30 generates the reset output signal S30a and the warning output signal S30b according to the anomaly detection signals S12 and S22.

### Electronic Apparatus (Third Example)

FIG. 5 is a diagram showing an overall configuration (third example) of an electronic apparatus X. Furthermore, the power supply control device 1 is the one shown in the aforementioned first embodiment (FIG. 4).

The electronic apparatus X of this configuration example comprises a power supply device 200 having a current supply capability greater than the power supply device 100, as in the aforementioned second example (FIG. 3). That is, the load device 2 is supplied with the output voltage Vo5 instead of the aforementioned output voltage Vo2.

Hence, in the power supply control device 1, the power supply control circuit 11 for generating the output voltage Vo2 is disabled. To describe based on this figure, the switch terminal SW2 is set to an open state, and the capacitor C8 and inductor L2 are omitted. Additionally, an output node of the power supply device 200 is connected to the output feedback terminal FB2. That is, the output voltage Vo5 is applied to the output feedback terminal FB2 instead of the unused output voltage Vo2.

According to this configuration example, the power supply control device 1 can monitor not only the output voltages Vo1 to Vo4 of the power supply device 100 but also the output voltage Vo5 of the power supply device 200 as monitoring targets. Thus, it is possible to omit the aforementioned output monitoring device 6 and centralize the output monitoring function in the power supply control device 1. As a result, cost improvements are expected as the number of external components is reduced. Additionally, by having the power supply control device 1 handle all output monitoring collectively, system design can become easier.

### Power Supply Control Device (Second Embodiment)

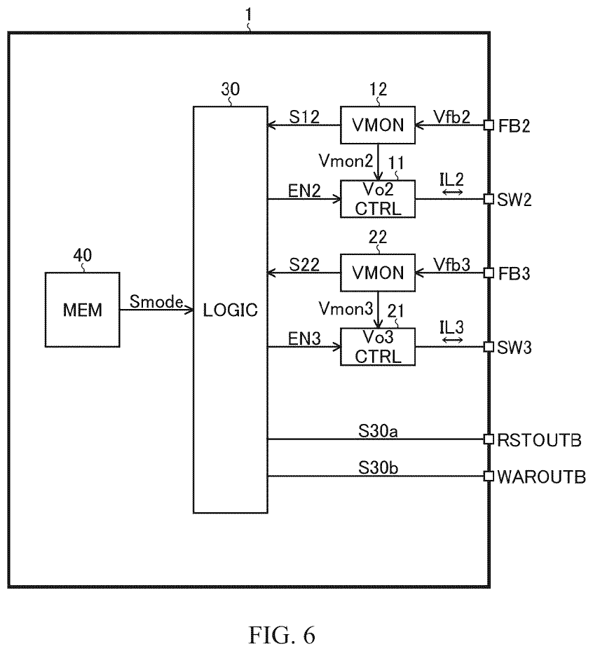

FIG. 6 is a diagram showing a second embodiment of the power supply control device 1. The power supply control device 1 of this embodiment is based on the aforementioned first embodiment (FIG. 4), and further comprises a memory circuit 40.

The memory circuit 40 stores a mode control signal Smode. The memory circuit 40 may be a non-volatile memory, such as OTPROM [one-time programmable read-only memory], etc. Additionally, the memory circuit 40 may be a volatile memory, such as a register, etc. Furthermore, the memory circuit 40 may also be externally attached to the power supply control device 1. In that case, an interface for signal exchange between the logic circuit 30 and the memory circuit 40 may be provided in the power supply control device 1.

The logic circuit 30 switches an enable/disable setting of each of the power supply control circuits 11 and 21 according to the mode control signal Smode read from the memory circuit 40.

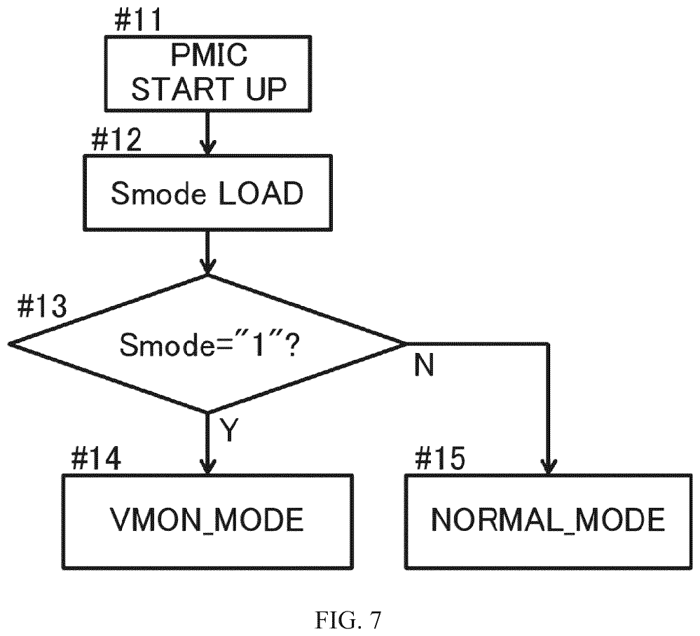

FIG. 7 is a diagram showing mode switching control in the second embodiment. Furthermore, this flow is executed by the logic circuit 30 unless otherwise specified. Additionally, in this figure, for simplicity, it is assumed that the mode control signal Smode is a single-bit signal that can take binary values “1” or “0”, and only an enable/disable setting of the power supply control circuit 11 is switched.

After the power supply control device 1 is started in Step #11, the mode control signal Smode is read from the memory circuit 40 in Step #12.

In Step #13, a determination is made as to whether the value of the mode control signal Smode is “1”. If a Yes determination is made here, the flow proceeds to Step #14. On the other hand, if a No determination is made, the flow proceeds to Step #15.

In Step #14, the power supply control circuit 11 is disabled. Thus, it becomes a state wherein a terminal voltage Vfb2 other than the output voltage Vo2, for example, the output voltage Vo5, can be applied to the output feedback terminal FB2 as an output monitoring target. This state can be understood as an output monitoring mode (VMON_MODE).

On the other hand, in Step #15, the power supply control circuit 11 is enabled. Thus, the power supply control circuit 11 controls the output voltage Vo2 according to the output voltage Vo2 applied to the output feedback terminal FB2. This state can be understood as a normal mode (NORMAL_MODE).

### Power Supply Control Device (Third Embodiment)

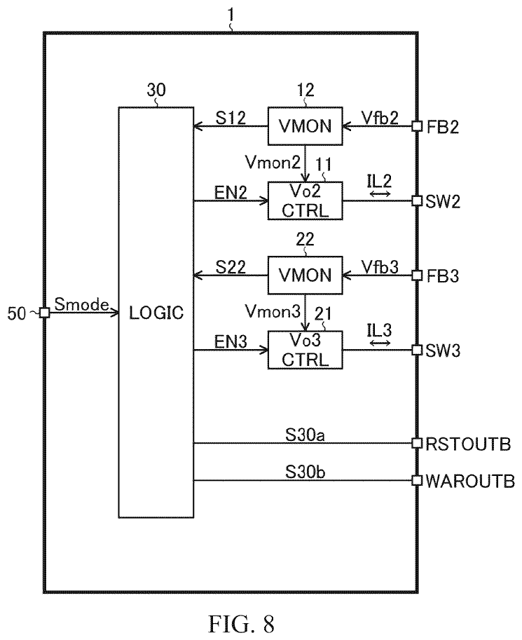

FIG. 8 is a diagram showing a third embodiment of the power supply control device 1. The power supply control device 1 of this embodiment is based on the aforementioned first embodiment (FIG. 4), and further comprises a mode control terminal 50.

The mode control terminal 50 receives an external input of the mode control signal Smode.

The logic circuit 30 switches an enable/disable setting of each of the power supply control circuits 11 and 21 according to the mode control signal Smode externally input to the mode control terminal 50.

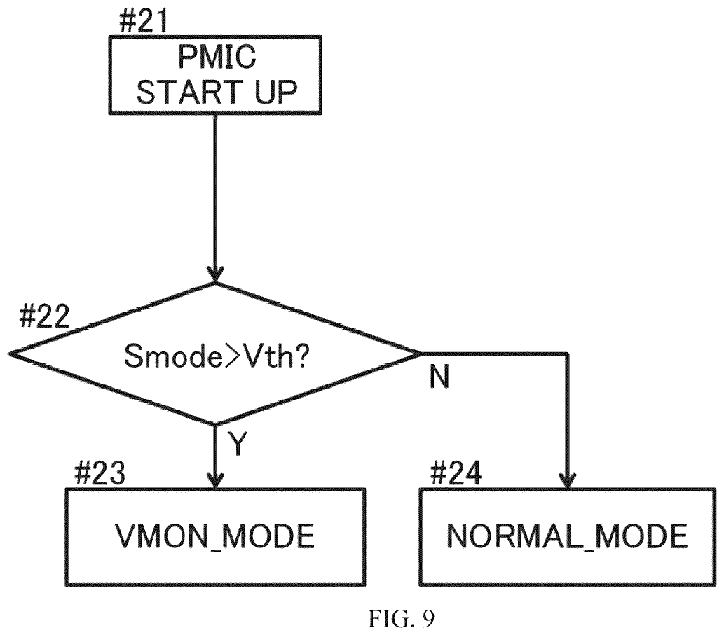

FIG. 9 is a diagram showing mode switching control in the third embodiment. Furthermore, this flow is executed by the logic circuit 30 unless otherwise specified. Additionally, in this figure, for simplicity, it is assumed that the mode control signal Smode is an analog voltage, and only an enable/disable setting of the power supply control circuit 11 is switched according to a comparison result with the threshold voltage Vth.

After the power supply control device 1 is started in Step #21, a determination is made in Step #22 as to whether the mode control signal Smode is higher than the threshold voltage Vth. If a Yes determination is made here, the flow proceeds to Step #23. On the other hand, if a No determination is made, the flow proceeds to Step #24.

In Step #23, the power supply control circuit 11 is disabled. Thus, it becomes a state wherein a terminal voltage Vfb2 other than the output voltage Vo2, for example, the output voltage Vo5, can be applied to the output feedback terminal FB2 as an output monitoring target. This state can be understood as the output monitoring mode (VMON_MODE).

On the other hand, in Step #24, the power supply control circuit 11 is enabled. Thus, the power supply control circuit 11 controls the output voltage Vo2 according to the output voltage Vo2 applied to the output feedback terminal FB2. This state can be understood as the normal mode (NORMAL_MODE).

### Power Supply Control Device (Fourth Embodiment)

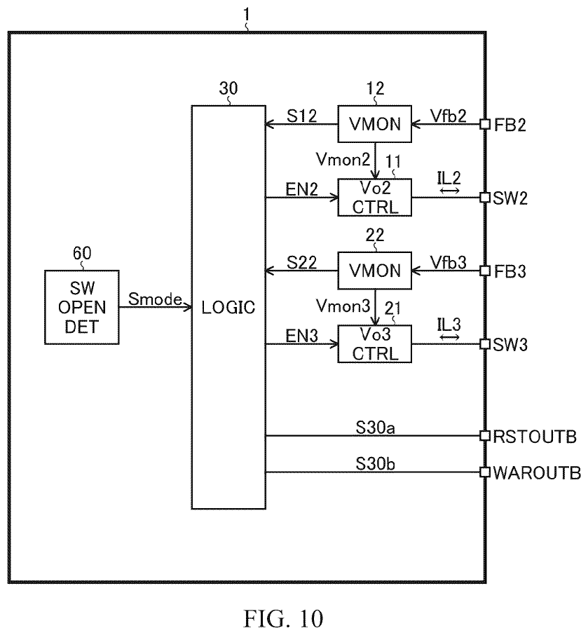

FIG. 10 is a diagram showing a fourth embodiment of the power supply control device 1. The power supply control device 1 of this embodiment is based on the aforementioned first embodiment (FIG. 4), and further comprises an output open detection circuit 60.

The output open detection circuit 60 detects whether output nodes of the power supply control circuits 11 and 12, i.e., the switch terminals SW2 and SW3, are each in an open state, and generates the mode control signal Smode.

The logic circuit 30 switches an enable/disable setting of each of the power supply control circuits 11 and 21 according to the mode control signal Smode generated by the output open detection circuit 60.

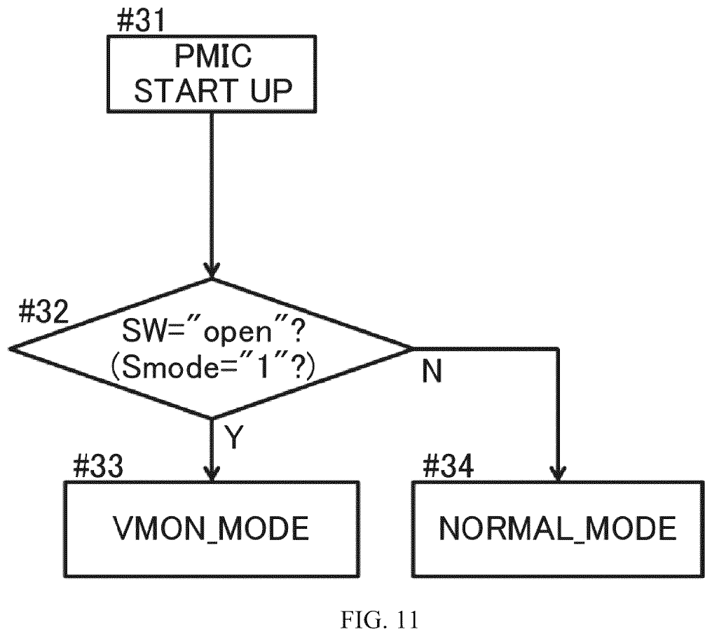

FIG. 11 is a diagram showing mode switching control in the fourth embodiment. Furthermore, this flow is executed by the logic circuit 30 unless otherwise specified. Additionally, in this figure, for simplicity, it is assumed that the mode control signal Smode is a single-bit signal that can take binary values “1” or “0”, and only an enable/disable setting of the power supply control circuit 11 is switched.

For example, when the switch terminal SW2 is in an open state, the value of the mode control signal Smode may be set to “1”. On the other hand, when the switch terminal SW2 is not in the open state, the value of the mode control signal Smode may be set to “0”.

After the power supply control device 1 is started in Step #31, a determination is made in Step #32 as to whether the switch terminal SW2 is in an open state, i.e., whether the value of the mode control signal Smode is “1”. If a Yes determination is made here, the flow proceeds to Step #33. On the other hand, if a No determination is made, the flow proceeds to Step #34.

In Step #33, the power supply control circuit 11 is disabled. Thus, it becomes a state wherein a terminal voltage Vfb2 other than the output voltage Vo2, for example, the output voltage Vo5, can be applied to the output feedback terminal FB2 as an output monitoring target. This state can be understood as the output monitoring mode (VMON_MODE).

On the other hand, in Step #34, the power supply control circuit 11 is enabled. Thus, the power supply control circuit 11 controls the output voltage Vo2 according to the output voltage Vo2 applied to the output feedback terminal FB2. This state can be understood as the normal mode (NORMAL_MODE).

### Power Supply Control Device (Fifth Embodiment)

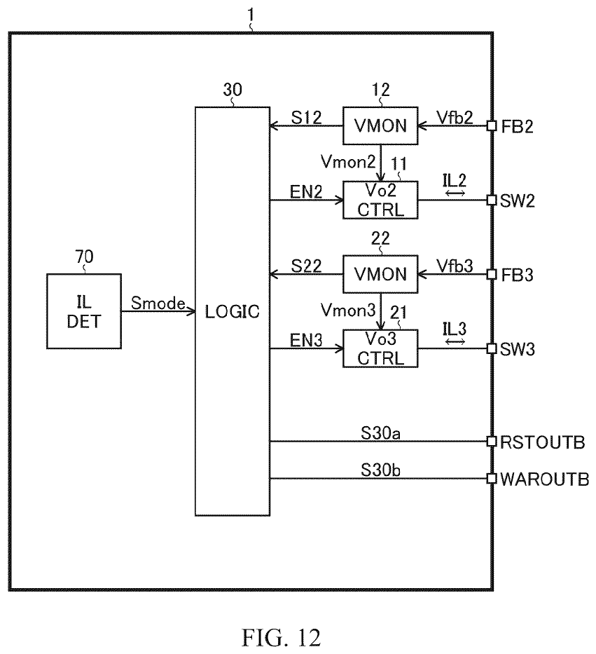

FIG. 12 is a diagram showing a fifth embodiment of the power supply control device 1. The power supply control device 1 of this embodiment is based on the aforementioned first embodiment (FIG. 4), and further comprises an output current detection circuit 70.

The output current detection circuit 70 detects whether the output currents IL2 and IL3, which can flow through each of the power supply control circuits 11 and 12, are smaller than the threshold current Ith, and generates a mode control signal Smode.

The logic circuit 30 switches an enable/disable setting of each of the power supply control circuits 11 and 21 according to the mode control signal Smode generated by the output current detection circuit 70.

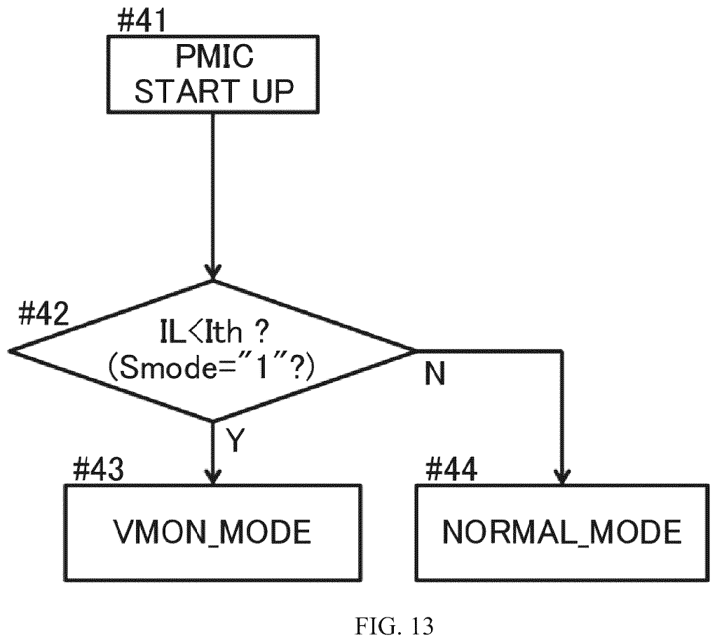

FIG. 13 is a diagram showing mode switching control in the fifth embodiment. Furthermore, this flow is executed by the logic circuit 30 unless otherwise specified. Additionally, in this figure, for simplicity, it is assumed that the mode control signal Smode is a single-bit signal that can take binary values “1” or “0”, and only an enable/disable setting of the power supply control circuit 11 is switched.

For example, when the output current IL2 is smaller than the threshold current Ith, the value of the mode control signal Smode may be set to “1”. On the other hand, when the output current IL2 is greater than the threshold current Ith, the value of the mode control signal Smode may be set to “0”.

After the power supply control device 1 is started in Step #41, a determination is made in Step #42 as to whether the output current IL2 is smaller than the threshold current Ith, that is, whether the value of the mode control signal Smode is “1”. If a Yes determination is made here, the flow proceeds to Step #43. On the other hand, if a No determination is made, the flow proceeds to Step #44.

In Step #43, the power supply control circuit 11 is disabled. Thus, it becomes a state wherein a terminal voltage Vfb2 other than the output voltage Vo2, for example, the output voltage Vo5, can be applied to the output feedback terminal FB2 as an output monitoring target. This state can be understood as the output monitoring mode (VMON_MODE).

On the other hand, in Step #44, the power supply control circuit 11 is enabled. Thus, the power supply control circuit 11 controls the output voltage Vo2 according to the output voltage Vo2 applied to the output feedback terminal FB2. This state can be understood as the normal mode (NORMAL_MODE).

### <Power Supply Control Circuit, Output Monitoring Circuit>

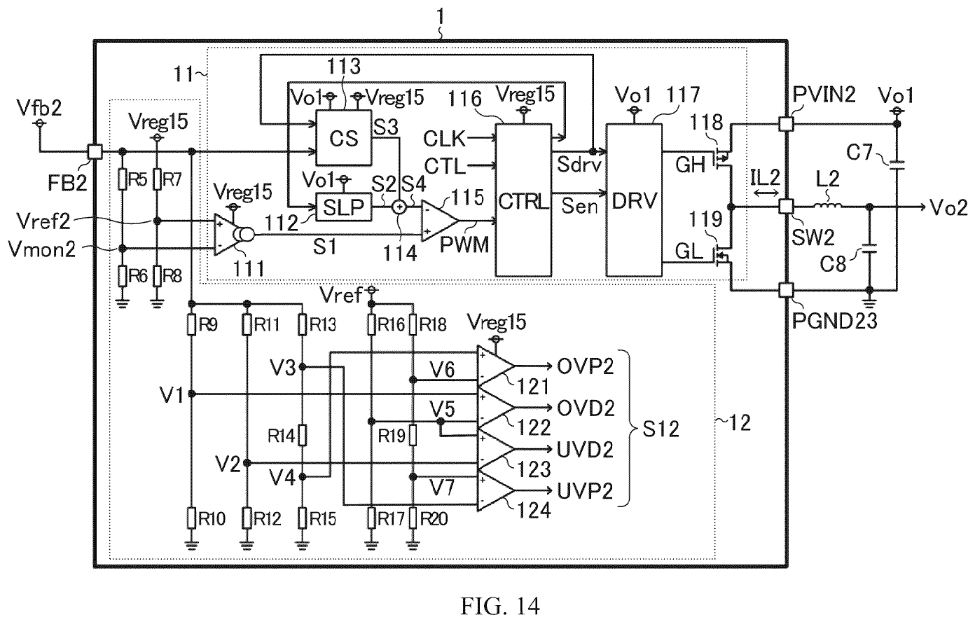

FIG. 14 is a diagram showing a configuration example of the power supply control circuit 11 and the output monitoring circuit 12. The power supply control circuit 11 in this configuration example includes an error amplifier 111, a slope signal generation circuit 112, a current detection circuit 113, an addition circuit 114, a comparator 115, a controller 116, a driver 117, and transistors 118 and 119.

The error amplifier 111 operates upon receiving a supply of the reference voltage Vreg15 (for example, 1.5 V). The error amplifier 111 outputs an error signal S1 according to a difference between the monitoring voltage Vmon2 input to an inverting input terminal (−) and a reference voltage Vref2 input to a non-inverting input terminal (+). The error amplifier 111 may be a current output amplifier, a so-called gm amplifier.

The slope signal generation circuit 112 operates upon receiving a supply of the output voltage Vo1 (for example, 3 to 5 V). The slope signal generation circuit 112 generates a slope signal S2 having a ramp waveform synchronized with the clock signal CLK input to the controller 116.

The current detection circuit 113 detects the output current IL2 flowing through the inductor L2 and generates a current detection signal S3. By applying a principle of a Wheatstone bridge circuit, the current detection circuit 113 may extract a voltage generated by an on-resistance of the transistors 118 and 119 and a direct current resistance of the inductor L2 as current feedback information. For example, the current detection circuit 113 may receive the terminal voltage Vfb2 (=Vo2) of the output feedback terminal FB2 and a drive signal Sdrv of the driver 117. The drive signal Sdrv may be level-shifted from the Vreg15 type to the Vo1 type within the current detection circuit 113. Through such level-shifting processing, each high-level potential and low-level potential between the level-shifted drive signal Sdrv and the terminal voltage of the switch terminal SW2 match. Thus, in the current detection circuit 113, the terminal voltage of the switch terminal SW2 can be pseudo-monitored.

The addition circuit 114 adds the slope signal S2 and the current detection signal S3 to generate an addition signal S4.

The comparator 115 compares the error signal S1 input to a non-inverting input terminal (+) and the addition signal S4 input to an inverting input terminal (−) to generate a pulse width modulation signal PWM.

The controller 116 operates upon receiving the supply of the reference voltage Vreg15. The controller 116 performs duty control of the drive signal Sdrv upon receiving the clock signal CLK and the pulse width modulation signal PWM. Additionally, the controller 116 switches an enable/disable setting of the power supply control circuit 11 upon receiving a control signal CTL. For example, the controller 116 generates an enable control signal Sen for the driver 117 according to the control signal CTL. The control signal CTL may include the aforementioned enable signal EN2 output from the logic circuit 30.

The driver 117 operates upon receiving a supply of the output voltage Vo1. When the driver 117 is in an enabled state, gate signals GH and GL are each generated according to the drive signal Sdrv. For example, when the drive signal Sdrv is at a high level, both gate signals GH and GL are set to a low level. On the other hand, when the drive signal Sdrv is at a low level, both gate signals GH and GL are set to a high level. Additionally, when the driver 117 is in a disabled state, the gate signal GH is set to a high level and the gate signal GL is set to a low level. That is, the switch terminal SW2 is in a high impedance state.

The transistor 118 functions as an upper switch of a half-bridge output stage. The transistor 118 may be of the P-channel type. In that case, a source of the transistor 118 is connected to the input terminal PVIN2. A drain of the transistor 118 is connected to the switch terminal SW2. A gate of the transistor 118 is connected to an application end of the gate signal GH. The transistor 118 is in the on state when the gate signal GH is at a low level and is in the off state when the gate signal GH is at a high level.

The transistor 119 functions as a lower switch of the half-bridge output stage. The transistor 119 may be of the N-channel type. In that case, a drain of the transistor 119 is connected to the switch terminal SW2. A source of the transistor 119 is connected to the ground terminal PGND23. A gate of the transistor 119 is connected to an application end of the gate signal GL. The transistor 119 is in the on state when the gate signal GL is at a high level and is in the off state when the gate signal GL is at a low level.

As such, in the power supply control circuit 11 of this configuration example, a current mode control method is adopted as the output feedback control method. However, the output feedback control method is not limited to this, and any topology may be adopted.

Additionally, the output monitoring circuit 12 of this configuration example includes resistors R5 to R20 and comparators 121 to 124.

The resistor R5 is connected between the output feedback terminal FB2 (=an application end of the terminal voltage Vfb2) and an application end of the monitoring voltage Vmon2. The resistor R6 is connected between the application end of the monitoring voltage Vmon2 and the ground end. The resistors R5 and R6 function as a resistive voltage divider circuit that divides the terminal voltage Vfb2 to generate the monitoring voltage Vmon2 (=Vfb2×R6/(R5+R6)).

The resistor R7 is connected between the application end of the reference voltage Vreg15 and an application end of the reference voltage Vref2. The resistor R8 is connected between the application end of the reference voltage Vref2 and the ground end. The resistors R7 and R8 function as a resistive voltage divider circuit that divides the reference voltage Vreg15 to generate the reference voltage Vref2 (=Vreg15×R8/(R7+R8)).

The resistor R9 is connected between the output feedback terminal FB2 (=the application end of the terminal voltage Vfb2) and an application end of a divided voltage V1. The resistor R10 is connected between the application end of the divided voltage V1 and the ground end. The resistors R9 and R10 function as a resistive voltage divider circuit that divides the terminal voltage Vfb2 to generate the divided voltage V1 (=Vfb2×R10/(R9+R10)).

The resistor R11 is connected between the output feedback terminal FB2 (=the application end of the terminal voltage Vfb2) and an application end of a divided voltage V2. The resistor R12 is connected between the application end of the divided voltage V2 and the ground end. The resistors R11 and R12 function as a resistive voltage divider circuit that divides the terminal voltage Vfb2 to generate the divided voltage V2 (=Vfb2×R12/(R11+R12)).

The resistor R13 is connected between the output feedback terminal FB2 (=the application end of the terminal voltage Vfb2) and an application end of a divided voltage V3. The resistor R14 is connected between the application end of the divided voltage V3 and an application end of a divided voltage V4. The resistor R15 is connected between the application end of the divided voltage V4 and the ground end. The resistors R13, R14, and R15 function as a resistive voltage divider circuit that divides the terminal voltage Vfb2 to generate the divided voltage V3 (=Vfb2×(R14+R15)/(R13+R14+R15)) and the divided voltage V4 (=Vfb2×R15/(R13+R14+R15)).

The resistor R16 is connected between an application end of the predetermined reference voltage Vref and an application end of a threshold voltage V5. The resistor R17 is connected between the application end of the threshold voltage V5 and the ground end. The resistors R16 and R17 function as a resistive voltage divider circuit that divides the reference voltage Vref to generate the threshold voltage V5 (=Vref×R17/(R16+R17)).

The resistor R18 is connected between the application end of the predetermined reference voltage Vref and an application end of a threshold voltage V6. The resistor R19 is connected between the application end of the threshold voltage V6 and an application end of a threshold voltage V7. The resistor R20 is connected between the application end of the threshold voltage V7 and the ground end. The resistors R18, R19, and R20 function as a resistive voltage divider circuit that divides reference voltage Vref to generate the threshold voltage V6 (=Vref×(R19+R20)/(R18+R19+R20)) and the threshold voltage V7 (=Vref×R20/(R18+R19+R20)).

Furthermore, a resistance value of each of the resistors R5 to R20 may be a variable value that can be arbitrarily adjusted.

The comparator 121 operates upon receiving the supply of the reference voltage Vreg15. The comparator 121 compares the divided voltage V4 input to a non-inverting input terminal (+) with the threshold voltage V6 input to the inverting input terminal (−) to generate an overvoltage detection signal OVP2. The overvoltage detection signal OVP2 becomes high level (=logical level when an anomaly is detected) when the divided voltage V4 is higher than the threshold voltage V6. On the other hand, the overvoltage detection signal OVP2 becomes low level (=logical level when no anomaly is detected) when the divided voltage V4 is lower than the threshold voltage V6.

The comparator 122 operates upon receiving the supply of the reference voltage Vreg15. The comparator 122 compares the divided voltage V1 input to a non-inverting input terminal (+) with the threshold voltage V5 input to an inverting input terminal (−) to generate an overvoltage precursor signal OVD2. The overvoltage precursor signal OVD2 becomes high level (=logical level when a precursor is detected) when the divided voltage V1 is higher than the threshold voltage V5. On the other hand, the overvoltage precursor signal OVD2 becomes low level (=logical level when no precursor is detected) when the divided voltage V1 is lower than the threshold voltage V5.

The comparator 123 operates upon receiving the supply of the reference voltage Vreg15. The comparator 123 compares the threshold voltage V5 input to a non-inverting input terminal (+) with the divided voltage V2 input to an inverting input terminal (−) to generate an undervoltage precursor signal UVD2. The undervoltage precursor signal UVD2 becomes high level (=logical level when a precursor is detected) when the divided voltage V2 is lower than the threshold voltage V5. On the other hand, the undervoltage precursor signal UVD2 becomes low level (=logical level when no precursor is detected) when the divided voltage V2 is higher than the threshold voltage V5.

The comparator 124 operates upon receiving the supply of the reference voltage Vreg15. The comparator 124 compares the threshold voltage V7 input to a non-inverting input terminal (+) with the divided voltage V3 input to an inverting input terminal (−) to generate an undervoltage detection signal UVP2. The undervoltage detection signal UVP2 becomes high level (=logic level when an anomaly is detected) when the divided voltage V3 is lower than the threshold voltage V7. On the other hand, the undervoltage detection signal UVP2 becomes low level (=logic level when no anomaly is detected) when the divided voltage V3 is higher than the threshold voltage V7.

Furthermore, the overvoltage detection signal OVP2, the overvoltage precursor signal OVD2, the undervoltage precursor signal UVD2, and the undervoltage detection signal UVP2 can be understood as the aforementioned anomaly detection signal S12. As such, the output monitoring circuit 12 generates the anomaly detection signal S12 by comparing the divided voltages V1 to V4, corresponding to the terminal voltage Vfb2, with the predetermined threshold voltages V6 to V7.

### Combination of Embodiments

The various embodiments introduced above may be arbitrarily combined to the extent that there is no contradiction. For example, the power supply control device 1 may include the memory circuit 40 of FIG. 6, the mode control terminal 50 of FIG. 8, the output open detection circuit 60 of FIG. 10, and the output current detection circuit 70 of FIG. 12 altogether. In that case, for example, the logic circuit 30 may disable the power supply control circuit 11 when a Yes determination is made in at least one of the steps of Step #13 of FIG. 7, Step #22 of FIG. 9, Step #32 of FIG. 11, and Step #42 of FIG. 13, and may enable the power supply control circuit 11 when a No determination is made in all of the above steps.

### APPENDIX

With the power supply control device according to the present disclosure, it is possible to centralize the output monitoring function. The following are appendices regarding the above disclosure.

### Appendix 1

A power supply control device (1), comprising:
an output feedback terminal (FB2, FB3);
a power supply control circuit (11, 21) configured to control an output voltage (Vo2, Vo3) according to a terminal voltage (Vfb2, Vfb3) of the output feedback terminal (FB2, FB3) when enabled;
an output monitoring circuit (12, 22) configured to monitor the terminal voltage (Vfb2, Vfb3) regardless of whether the power supply control circuit (11, 21) is enabled or disabled; and
a logic circuit (30) configured to switch an enable/disable setting of the power supply control circuit (11, 21) and generate an output signal (S30a, S30b) according to a monitoring result of the terminal voltage (Vfb2, Vfb3).

### Appendix 2

The power supply control device (1) of Appendix 1, wherein the output feedback terminal (FB2, FB3), the power supply control circuit (11, 21), and the output monitoring circuit (12, 22) are provided in multiple sets.

### Appendix 3

The power supply control device (1) of Appendix 1 or 2, further comprising a memory circuit (40), wherein the logic circuit (30) switches an enable/disable setting of the power supply control circuit (11, 21) according to a mode control signal (Smode) read from the memory circuit (40).

### Appendix 4

The power supply control device (1) of any of Appendices 1 to 3, further comprising a mode control terminal (50),
wherein the logic circuit (30) switches an enable/disable setting of the power supply control circuit (11, 21) according to a mode control signal (Smode) externally input to the mode control terminal (50).

### Appendix 5

The power supply control device (1) of any of Appendices 1 to 4, further comprising an output open detection circuit (60) configured to detect whether an output node (SW2, SW3) of the power supply control circuit (11, 21) is in an open state and generate a mode control signal (Smode),
wherein the logic circuit (30) switches an enable/disable setting of the power supply control circuit (11, 21) according to the mode control signal (Smode).

### Appendix 6

The power supply control device (1) of any of Appendices 1 to 5, further comprising an output current detection circuit (70) configured to detect whether an output current (IL2, IL3) flowing through the power supply control circuit (11, 21) is smaller than a threshold current (Ith) and generate a mode control signal (Smode),
wherein the logic circuit (30) switches an enable/disable setting of the power supply control circuit (11, 21) according to the mode control signal (Smode).

### Appendix 7

The power supply control device (1) of any of Appendices 1 to 6, wherein the output monitoring circuit (12, 22) compares at least one divided voltage (V1, V2, V3, V4) corresponding to the terminal voltage (Vfb2, Vfb3) with at least one threshold voltage (V5, V6, V7) and generates at least one anomaly detection signal (OVP2, OVD2, UVD2, UVP2).

### Appendix 8

A power supply device (100), comprising the power supply control device (1) of any of Appendices 1 to 7, wherein the power supply device generates at least one of the output voltages (Vo2, Vo3).

### Appendix 9

An electronic apparatus (X), comprising:
the power supply device (100) of Appendix 8; and
a signal processing device (3) configured to receive an input of the output signal (S30a, S30b).

### Appendix 10

The electronic apparatus (X) of Appendix 9, comprising:
a second power supply device (200) configured to have a current supply capability greater than the power supply device (100); and
a load device (2) configured to receive power supply from the second power supply device (200),
wherein the power supply control circuit (11) is disabled, and an output node of the second power supply device (200) is connected to the output feedback terminal (FB2).

### Other

Furthermore, in addition to the above embodiments, the various technical features disclosed in this specification can be modified in various ways without departing from the spirit of the technical creation. That is, the above embodiments should be considered in all respects as illustrative and not restrictive. Additionally, the technical scope of the present disclosure is defined by the claims, and should be understood to include all modifications that fall within the meaning and scope of the claims and equivalents.

1. A power supply control device, comprising:
an output feedback terminal;
a power supply control circuit configured to control an output voltage according to a terminal voltage of the output feedback terminal when enabled;
an output monitoring circuit configured to monitor the terminal voltage regardless of whether the power supply control circuit is enabled or disabled; and
a logic circuit configured to switch an enable/disable setting of the power supply control circuit and generate an output signal according to a monitoring result of the terminal voltage.

2. The power supply control device of claim 1, wherein the output feedback terminal, the power supply control circuit, and the output monitoring circuit are provided in multiple sets.

3. The power supply control device of claim 1, further comprising a memory circuit,
wherein the logic circuit switches an enable/disable setting of the power supply control circuit according to a mode control signal read from the memory circuit.

4. The power supply control device of claim 1, further comprising a mode control terminal,
wherein the logic circuit switches an enable/disable setting of the power supply control circuit according to a mode control signal externally input to the mode control terminal.

5. The power supply control device of claim 1, further comprising an output open detection circuit configured to detect whether an output node of the power supply control circuit is in an open state and generate a mode control signal,
wherein the logic circuit switches an enable/disable setting of the power supply control circuit according to the mode control signal.

6. The power supply control device of claim 1, further comprising an output current detection circuit configured to detect whether an output current flowing through the power supply control circuit is smaller than a threshold current and generate a mode control signal,
wherein the logic circuit switches an enable/disable setting of the power supply control circuit according to the mode control signal.

7. The power supply control device of claim 1, wherein the output monitoring circuit compares at least one divided voltage corresponding to the terminal voltage with at least one threshold voltage and generates at least one anomaly detection signal.

8. A power supply device, comprising the power supply control device of claim 1, wherein the power supply device generates at least one of the output voltages.

9. An electronic apparatus, comprising:
the power supply device of claim 8; and
a signal processing device configured to receive an input of the output signal.

10. The electronic apparatus of claim 9, comprising:
a second power supply device configured to have a current supply capability greater than the power supply device; and
a load device configured to receive power supply from the second power supply device,
wherein the power supply control circuit is disabled, and an output node of the second power supply device is connected to the output feedback terminal.
